(19) United States
(12) Patent Application Publication
(10) Pub. No.: US 2007/0289944 A1
(43) Pub. Date: Dec. 20, 2007

(54) Method for engraving a golf club head

(75) Inventors: Chon-Chen Lin, Ping-Tung Hsien (TW); Shun-Fu Hu, Ping-Tung Hsien (TW); Yen-Chi Hsu, Ping-Tung Hsien (TW)

Correspondence Address: OSTROLENK, FABER, GERB & SOFFEN, LLP, 1180 Avenue of the Americas, New York, NY, 10036-8403, US

(73) Assignee: O-TA PRECISION INDUSTRY CO., LTD.

(21) Appl. No.: 11/471,172

(22) Filed: Jun. 19, 2006

(51) Int. Cl. C23F 1/00; B44C 1/22; G03C 5/00

(52) U.S. Cl. 216/41; 430/346; 216/83

(57) ABSTRACT

A method for engraving a golf club head includes the steps of: a) applying a shielding layer on a surface of the golf club head; b) forming a predetermined patterning hole in the shielding layer by removing a part of the shielding layer; c) spraying an etching agent on the shielding layer so as to etch the surface of the golf club head through the predetermined patterning hole in order to form a patterning indentation in the surface; and d) removing the shielding layer from the golf club head.

### BACKGROUND OF THE INVENTION

1. Field of the Invention

The invention relates to a method for engraving a golf club head, more particularly to a method for engraving a golf club head by spraying an etching agent.

2. Description of the Related Art

A conventional method for fabricating a golf club head includes the stages of making of wax patterns, assembly of wax sticks, ceramic shell building, dewaxing, casting, knockout, cut off of parts, and finishing. In the finishing stage, various patterns, such as company details, are engraved on the golf club head by CNC engraving, screen printing, blasting, photolithography, laser etching, or the like. The conventional photolithography includes the steps of applying a photoresist, light-exposing through a photomask, soaking in an etching solution, removing the photoresist, and washing. Since it is difficult to control the etching extent of the golf club head soaked in the etching solution, and since the etching stress encountered by the golf club head soaked in the etching solution is not even, the quality of the patterns formed on the golf club head is not satisfactory.

### SUMMARY OF THE INVENTION

The object of the present invention is to provide a method for engraving a golf club head by spraying an etching agent so as to improve the quality and precision of the pattern formed on the golf club head.

Accordingly, the method for engraving a golf club head of this invention includes the steps of:

a) applying a shielding layer on a surface of the golf club head;

b) forming a predetermined patterning hole in the shielding layer by removing a part of the shielding layer;

c) spraying an etching agent on the shielding layer so as to etch the surface of the golf club head through the predetermined patterning hole in order to form a patterning indentation in the surface; and

d) removing the shielding layer from the golf club head.

### BRIEF DESCRIPTION OF THE DRAWINGS

Other features and advantages of the present invention will become apparent in the following detailed description of the preferred embodiments with reference to the accompanying drawings, of which:

FIG. 1 is a flow diagram of the first preferred embodiment of a method for engraving a golf club head according to this invention;

FIG. 2 is a schematic sectional view illustrating the steps of the method of the first preferred embodiment;

FIG. 3 is a schematic sectional view illustrating the steps of the second preferred embodiment of a method for engraving a golf club head according to this invention; and

FIG. 4 is a schematic sectional view illustrating the steps of the third preferred embodiment of a method for engraving a golf club head according to this invention.

### DETAILED DESCRIPTION OF THE PREFERRED EMBODIMENTS

Before the present invention is described in greater detail, it should be noted that like elements are denoted by the same reference numerals throughout the disclosure.

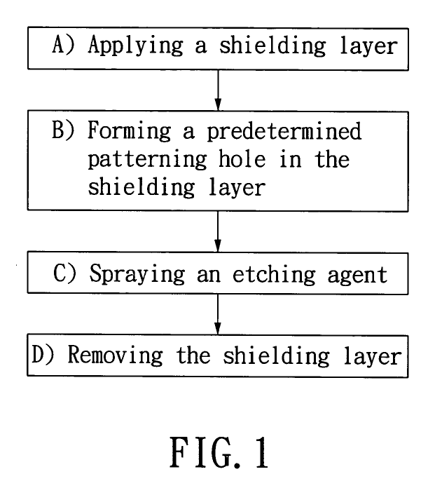

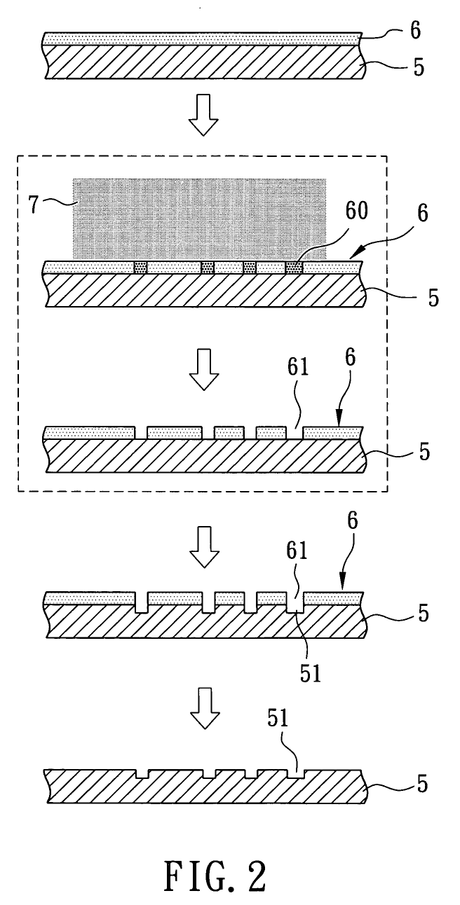

Referring to FIGS. 1 and 2, the first preferred embodiment of a method for engraving a golf club head according to this invention includes the steps of:

A) applying a shielding layer:
A shielding layer 6 is applied on a surface of a golf club head 5. In this preferred embodiment, the shielding layer 6 is a positive photoresist.

B) forming a predetermined patterning hole in the shielding layer:
In this step, a predetermined patterning hole 61 is formed in the shielding layer 6 by removing a part of the shielding layer 6. Specifically, a photomask 7 provided with a pattern (for example, a trademark, a model number, or the like) corresponding to that to be engraved on the surface of the golf club head 5 is placed on the shielding layer 6. The shielding layer 6 is exposed to light through the pattern of the photomask 7 to form a photo-reacted area 60 on the shielding layer 6 corresponding to the pattern of the photomask 7. The photo-reacted area 60 of the shielding layer 6 is removed via development so as to form the predetermined patterning hole 61 in the shielding layer 6.

C) spraying an etching agent:
An etching agent, such as an acid solution, is sprayed on the shielding layer 6 by using a spraying device under an appropriate spraying condition for an appropriate time period so as to etch the surface of the golf club head 5 through the predetermined patterning hole 61 of the shielding layer 6 in order to form a patterning indentation 51 in the surface of the golf club head 5.

D) removing the shielding layer:
The shielding layer 6 is removed from the golf club head 5 by using a washing agent, such as an organic solvent, so as to result in the predetermined pattern engraved on the surface of the golf club head 5.
In view of the aforesaid, since the etching agent is sprayed on the shielding layer 6 under an appropriate spraying condition for an appropriate time period, the patterning indentation 51 can be formed precisely in the surface of the golf club head 5. Therefore, the quality and precision of the pattern formed on the golf club head 5 can be improved.

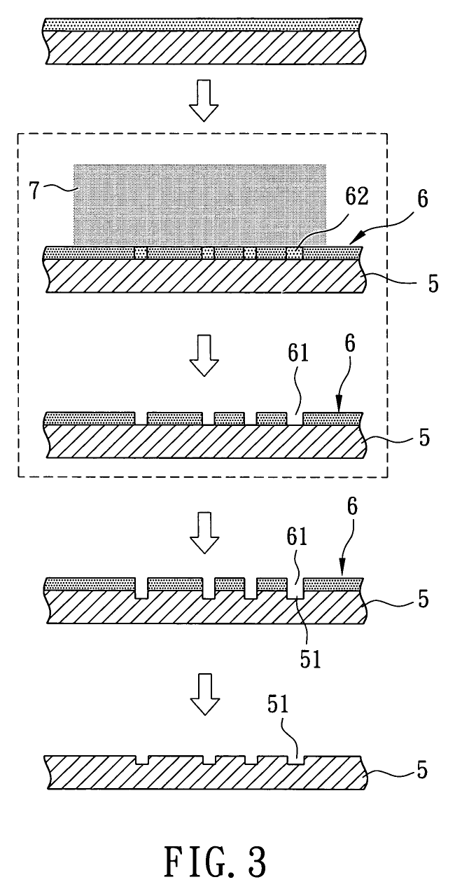

Referring to FIG. 3, the second preferred embodiment of a method for engraving a golf club head according to this invention is shown to be similar to the first preferred embodiment except that the shielding layer 6 is a negative photoresist. A non-photo-reacted area 62 is formed on the shielding layer 6 and is removed via development so as to form the predetermined patterning hole 61 in the shielding layer 6.

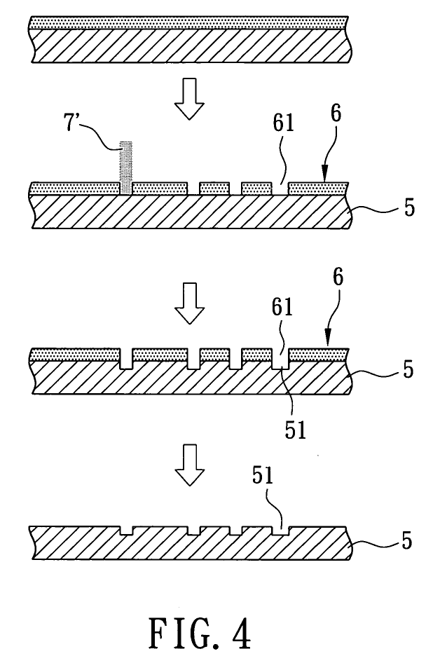

Referring to FIG. 4, the third preferred embodiment of a method for engraving a golf club head according to this invention is shown to be similar to the first preferred embodiment except that the shielding layer 6 is an etch resistant insulating material, and that a laser beam 7′ is used to form the predetermined patterning hole 61. The etch resistant insulating material suitable for this preferred embodiment is insulating painting, polymer, wax, or the like. The laser beam 7′ suitable for this preferred embodiment is carbon dioxide laser beam, argon laser beam, or the like at a low power, for example, of 1-200 W. Specifically, the laser beam 7′ is moved along a predetermined path corresponding to the pattern to be engraved on the surface of the golf club head 5 so as to form the predetermined patterning hole 61 in the shielding layer 6.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A method for engraving a golf club head, comprising the steps of:
a) applying a shielding layer on a surface of the golf club head;
b) forming a predetermined patterning hole in the shielding layer by removing a part of the shielding layer;
c) spraying an etching agent on the shielding layer so as to etch the surface of the golf club head through the predetermined patterning hole in order to form a patterning indentation in the surface; and
d) removing the shielding layer from the golf club head.

2. The method as claimed in claim 1, wherein the step b) is conducted by placing a photomask on the shielding layer and by exposing the shielding layer to light through the photomask followed by development.

3. The method as claimed in claim 2, wherein the shielding layer is a positive photoresist.

4. The method as claimed in claim 3, wherein in the step b), a photo-reacted area of the shielding layer is removed to form the patterning hole.

5. The method as claimed in claim 2, wherein the shielding layer is a negative photoresist.

6. The method as claimed in claim 5, wherein in the step b), a non-photo-reacted area of the shielding layer is removed to form the patterning hole.

7. The method as claimed in claim 1, wherein the shielding layer is an etch resistant insulating material.

8. The method as claimed in claim 7, wherein in the step b), a laser beam is used to form the predetermined patterning hole.
